(19) United States
(12) Patent Application Publication
(10) Pub. No.: US 2007/0011157 A1
(43) Pub. Date: Jan. 11, 2007

(54) Systems and methods for application management and related devices

(75) Inventor: Ding-Chiang Tang, Changhua City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/175,608

(22) Filed: Jul. 6, 2005

(51) Int. Cl. G06F 17/30

(52) U.S. Cl. 707/6

(57) ABSTRACT

Systems and methods applicable in a device. The system comprises a mapping table and a processing unit. The mapping table comprises a plurality of mapping rules, each corresponding to at least one instruction, wherein the instruction is involved with at least one component of the device. The system compares the identification to the mapping rules. If the identification conforms to one of the mapping rules, the system will operates the component involved with the instruction corresponding to the mapping rule to perform the instruction.

### BACKGROUND

The present disclosure relates generally to application management, and more particularly, to systems and methods that dynamically perform instructions in integration with components of a device based on an identification, and related devices.

Devices, such as mobile phones, smart phones, and PDAs have become integral tools used extensively to perform a wide variety of useful applications, such as telecommunication, music playback, camera, game, internet services, and others. New applications are developed on devices as a result of advances in hardware technology and rapid development in software technology. The growth in popularity together with the abundance of useful new applications contributes to a strong demand for such devices.

Generally, such devices have the capability to display information on a screen. For example, if a call is made or received on the device, the caller's name will be retrieved form a database and displayed on a screen. The capability to show other relating information, however, is limited.

### SUMMARY

In conventional devices, other information, such as billing information for a call, and personal information or to-do content regarding a called party, cannot be displayed when dialing or receiving a call. To overcome the disadvantage, in the present invention, systems and methods for application management and related devices are provided.

The system comprises a mapping table and a processing unit. The mapping table comprises a plurality of mapping rules, each corresponding to at least one instruction, wherein the instruction is involved with at least one component of the device. The system compares the identification to the mapping rules. If the identification conforms to one of the mapping rules, the system will operates the component involved with the instruction corresponding to the matched mapping rule to perform the instruction.

In a method for application management in a device, an identification is received on the device. The identification is compared to a mapping table. The mapping table comprises a plurality of mapping rules, each comprising at least one instruction, wherein the instruction is involved with at least one component of the device. The method compares the identification to the mapping rules. If the identification conforms to one of the mapping rules, the method will operates the component involved with the instruction corresponding to the matched mapping rule to perform the instruction.

Systems and methods for application management may take the form of program code embodied in tangible media. When the program code is loaded into and executed by a machine, the machine becomes an apparatus for practicing the disclosed methods.

### DESCRIPTION OF THE DRAWINGS

The invention will become more fully understood by referring to the following detailed description with reference to the accompanying drawings, wherein:

FIG. 1 is a schematic diagram illustrating an embodiment of a system for application management;

FIG. 2 is a flowchart of an embodiment of a method for application management;

FIG. 3 is an example of a mapping table;

FIG. 4 is a flowchart of an embodiment of a method for providing billing information;

FIG. 5 is a flowchart of an embodiment of a method for providing to-do content;

FIG. 6 is an example of an address book;

FIG. 7 is an example of a to-do list 700;

FIG. 8 is a schematic diagram illustrating an embodiment of linked components for FIG. 4; and

FIG. 9 is a schematic diagram illustrating an embodiment of linked components for FIG. 5.

### DESCRIPTION

Systems and methods for application management and related devices are provided.

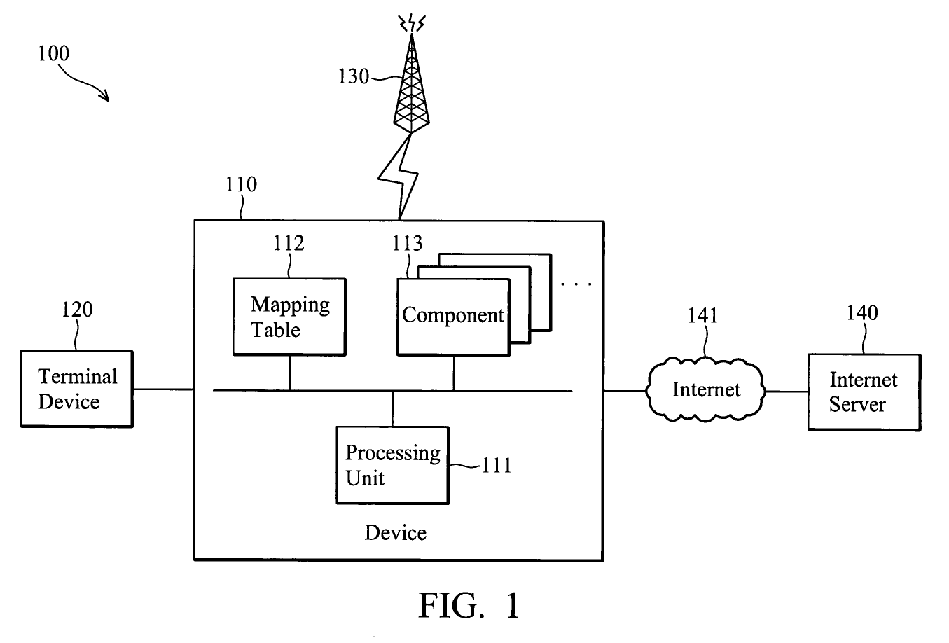

FIG. 1 is a schematic diagram illustrating an embodiment of a system for application management.

The system 100 comprises a device 110, such as a fixed line or mobile phone, a smart phone, or a PDA. The device 110 comprises a processing unit 111, a mapping table 112, and a plurality of components 113.

The processing unit 111 may be a MCU (Micro Control Unit), such as an ARM (Advanced RISC Machines) processor, performing related calculation and determination on the device 110. The components 113 may be some system resources, software or hardware. The components 113 may include system clock, GSM (Global System for Mobile telecommunication) service, MP3 player, camera, address book, contact list, to-do list, game, WAP (Wireless Application Protocol) over GPRS (General Packet Radio Service), Wi-Fi, storage device, screen, speaker modules, or others.

The mapping table 112 comprises a plurality of mapping items, each comprising a mapping rule and at least one instruction. The mapping rule may be identification, such as a name, a complete phone number, or a partial phone number. In some embodiments, the partial phone number can be represented in regular expressions, such as “XXXX-XXXX”, “XXXXXXXX”, “XX-XXXX-XXXX”, “XX-XXXXXXXX”, “0933XXXXXXX”, “0933-XXX-XXX”, and others, in which “X” represents an arbitrary number. It is understood that the regular expressions are flexible and are dependent on telecommunication systems and user behavior.

The instruction may include displaying strings on a screen (not shown) of the device 110, and/or generating audio output via a speaker (not shown) of the device 110. In some embodiments, the instruction may involve with specific components 113. If an identification conforms to a mapping rule of any mapping item in the mapping table 112, the corresponding instruction of the mapping item will be performed. It is understood that identification may be acquired from signals of an incoming call, or directly inputted when dialing a call, checking address books, and others.

The mapping table 112 can be updated or provided in various ways. A service provider (not shown) can voluntarily provide or transmit mapping items and/or related information, such as billing information, to the device 110 over the air (OTA) using SMS (Short Message Service), MMS (Multimedia Message Service), and/or WAP push via a base station 130. In some embodiments, the data sent from the service provider has a specific format, and the device 110 can parse and store the data in the mapping table 112 or related components. The device 110 can actively visit the service provider using WAP and download related data. Similarly, the device 110 can connect to an internet server 140 via Internet 141, and update the mapping table 112 accordingly. Additionally, the mapping table 112 can be edited using the device 110 directly, or via a terminal device 120, such as a computer system. It is understood that the instruction may require integration with specific components. In some embodiments, the content of mapping item can be acquired by static or dynamic linking to the components. For example, a mapping item comprises a regular expression, and an instruction to display corresponding billing information. In static linking, the billing information can be retrieved from a billing database (not shown), and stored in the mapping table 112 in advance. If a phone number conforms to the regular expression, the billing information is directly retrieved and displayed from the mapping table 112. In dynamic linking, the billing information is not stored in the mapping table 112. If a phone number conforms to the regular expression, the billing database is dynamically linked, and the billing information is retrieved and displayed therefrom.

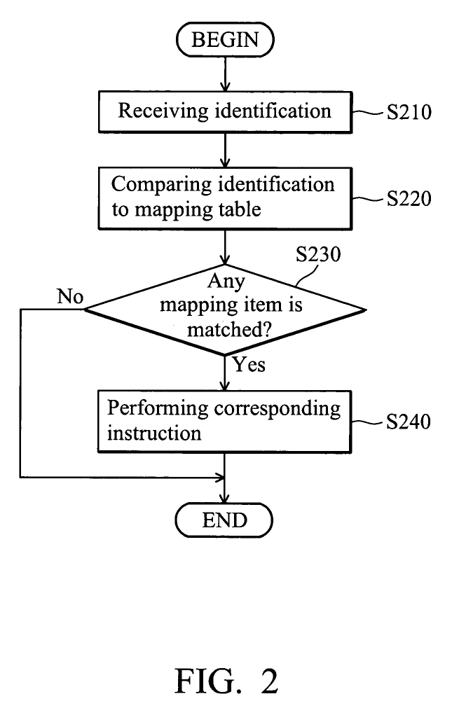

FIG. 2 is a flowchart of an embodiment of a method for application management. In step S210, an identification is received or provided. The identification may be acquired from signals of an incoming call, or directly inputted when dialing a call, checking address books, or others. In step S220, the identification is compared to the mapping items of the mapping table. It is understood that the mapping items comprises a mapping rule and at least one instruction. If no mapping item is matched, the procedure is complete. If the identification conforms to the mapping rule of one specific mapping item (Yes in step S230), in step S240, the corresponding instruction is performed.

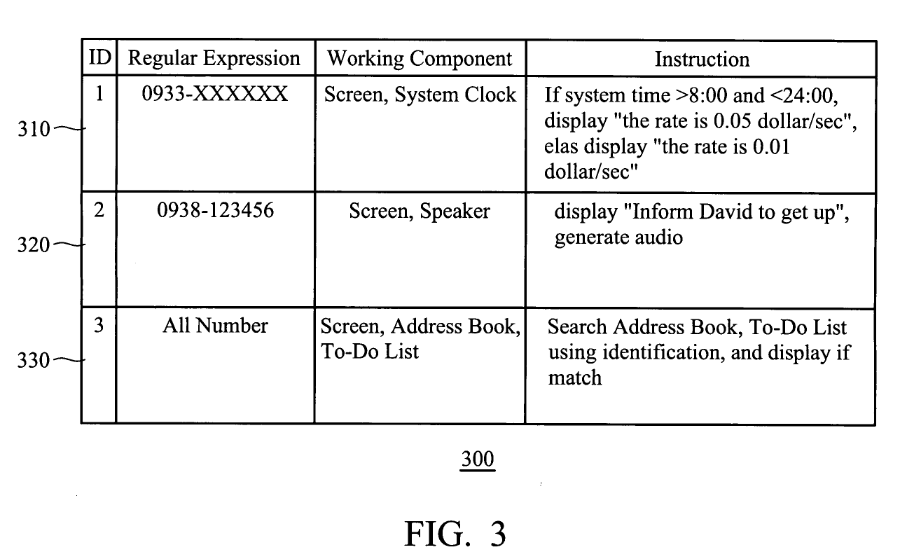

FIG. 3 is an example of a mapping table 300. As shown in FIG. 3, mapping items 310, 320, and 330 are listed in the mapping table 300. Each mapping item records a regular expression, working components, and corresponding instructions. It is understood that the working components are the components required to be used or operated according to the instruction. Further, the format for instructions is not limited thereto.

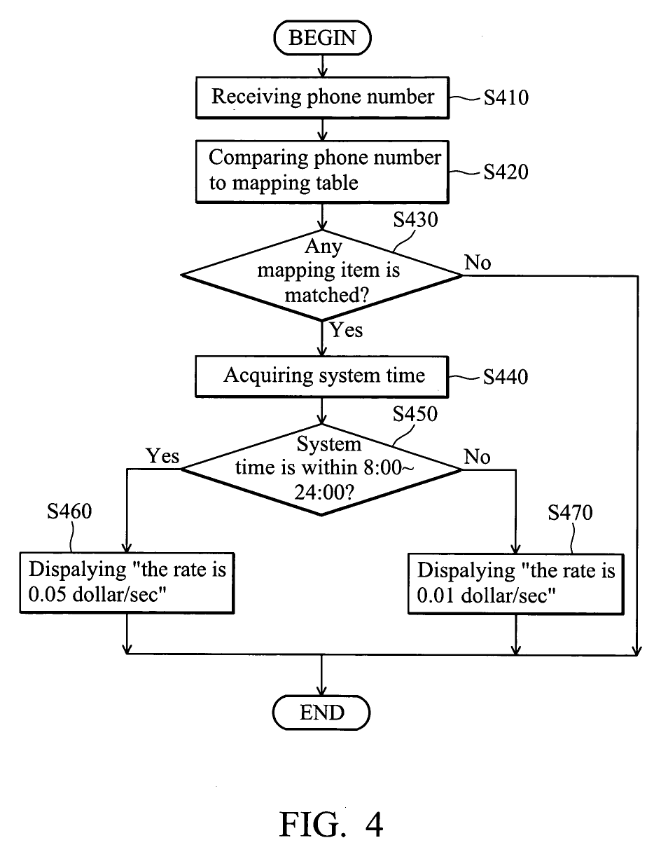

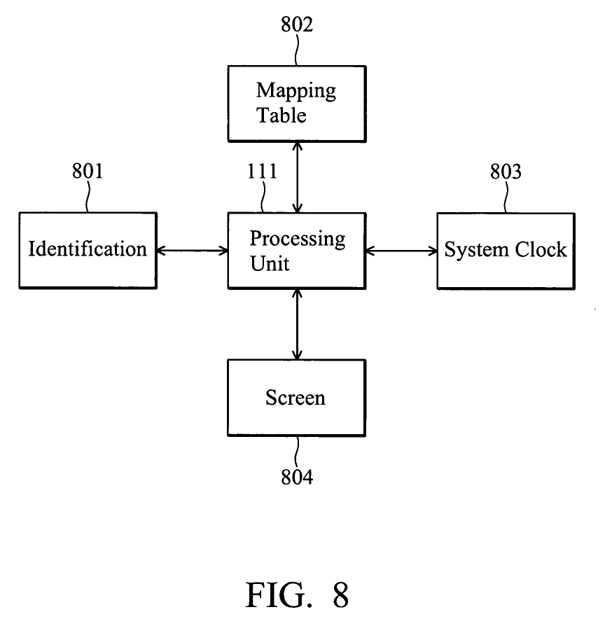

FIG. 4 is a flowchart of an embodiment of a method for providing billing information. Note that, not only information can be retrieved and displayed, but also related components of the device can be dynamically operated to perform corresponding instructions. FIG. 8 is a schematic diagram illustrating an embodiment of linked components for FIG. 4. In this embodiment, the identification 801, mapping table 802, system clock 803 and screen 804 are linked with the processing unit 111.

In step S410, a phone number is received. In this embodiment, phone number “0933-121121” is received. In step S420, the phone number is compared to the mapping items of the mapping table. Since the phone number “0933-121121” matches the regular expression “0933-XXXXXX” of the mapping item 310 in FIG. 3 (Yes in step S430), in step S440, a system time is retrieved from the system clock. In step S450, it is determined whether the system time is within 8:00 to 24:00. If yes, in step S460, string “the rate is 0.05 dollar/sec” is displayed. Otherwise, in step S470, string “the rate is 0.01 dollar/sec” is displayed. It should be noted that the billing information in the mapping table can be downloaded from a system server and regularly updated by the system operator, or manually inputted/edited by users.

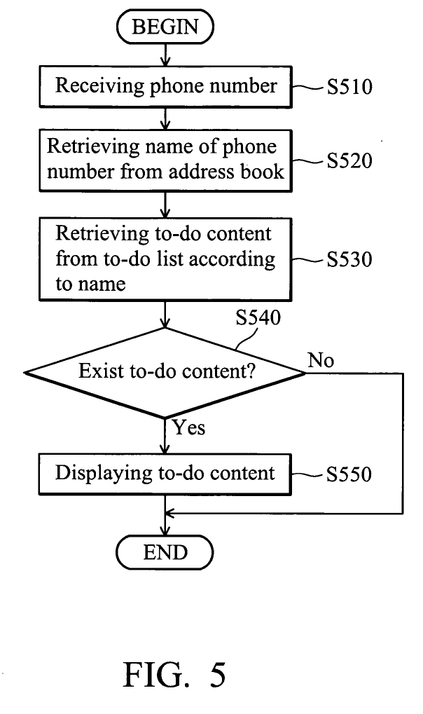

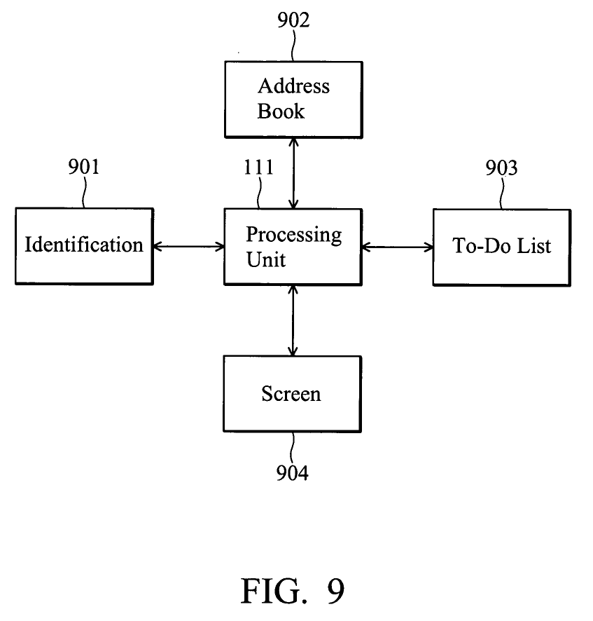

FIG. 5 is a flowchart of an embodiment of a method for providing to-do content. In this embodiment, related components are dynamically linked. FIG. 9 is a schematic diagram illustrating an embodiment of linked components for FIG. 5. In this embodiment, the identification 901, address book 902, to-do list 903 and screen 904 are linked with the processing unit 111.

In step S510, a phone number is received or provided. In step S520, when choosing to link to the address book, a name corresponding to the phone number is retrieved. In step S530, based on the instruction listed in the mapping table of FIG. 3, the to-do list is further linked and to-do content corresponding to the name is retrieved therefrom. If no to-do content exists for the name (No in step S540), the procedure is complete. If yes (Yes in step S540), in step S550, the to-do content is displayed.

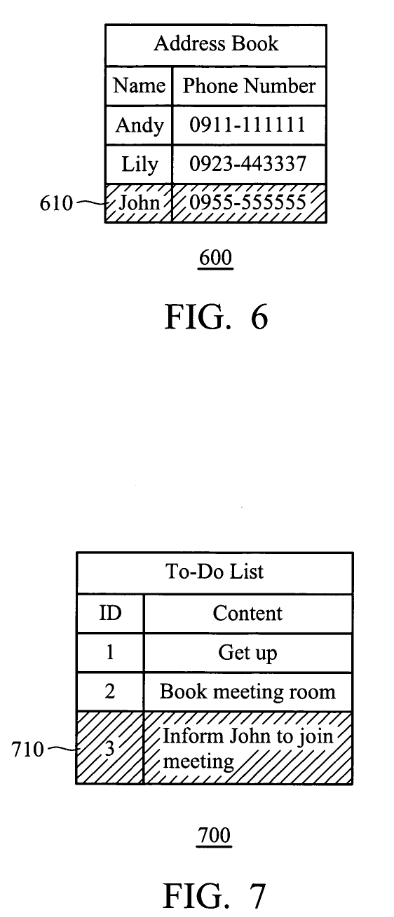

FIG. 6 is an example of an address book 600, and FIG. 7 is an example of a to-do list 700. For example, a phone number “0955-555555” is received. A name “John” 610 is first retrieved from the address book 600 according to the phone number “0955-555555”. The to-do list 700 is then sought according to the name “John”. Since “John” is found in the content list at ID 3 (710), the corresponding to-do content “Inform John to join meeting” is retrieved and displayed. It is understood that the method for providing to-do content can be either in static. In static link, the to-do list is first checked, and a name “John” is found therein. The phone number “0955-555555” of “John” is then retrieved from the address book. A new mapping item is generated in the mapping table, the phone number “0955-555555” is set as the mapping rule of the new mapping item, and the to-do content “Inform John to join meeting” in the to-do list is set to be displayed as the instruction of the new mapping item.

Systems and methods for application management, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A system applicable to a device, comprising:
a means for providing an identification;
a mapping table comprising a plurality of mapping rules, each corresponding to at least one instruction, wherein the instruction is involved with at least one component of the device; and
a processing unit comparing the identification to the mapping rules, and if the identification conforms to one of the mapping rules, operating the component involved with the instruction corresponding to the mapping rule to perform the instruction.

2. The system of claim 1, wherein the identification comprises a phone number, and the processing unit retrieves a name corresponding to the phone number from an address book of the device, and retrieves to-do content from a to-do list of the device according to the name.

3. The system of claim 2 wherein the processing unit further displaying the to-do content on the device.

4. The system of claim 1 wherein the processing unit further checks a system time, and performs the corresponding instruction according to the system time.

5. The system of claim 1 wherein the instruction comprises displaying a string.

6. The system of claim 5 wherein the identification comprises a phone number, and the string comprises billing information therefor.

7. The system of claim 4 wherein the identification comprises a phone number, and the instruction comprises displaying billing information for the phone number at the system time.

8. The system of claim 1 wherein the instruction comprises generating audio output.

9. The system of claim 1 wherein the device is a mobile phone, a smart phone, or a PDA.

10. The system of claim 1, wherein the system is part of an integrated circuit (IC) therein.

11. A method applicable to a device, comprising:
providing an identification;
providing a mapping table comprising a plurality of mapping rules, each corresponding to at least one instruction, wherein the instruction is involved with at least one component of the device;
comparing the identification to the mapping rule; and
if the identification conforms to the mapping rule, operating the component involved with the instruction corresponding to the mapping rule to perform the instruction.

12. The method of claim 11 wherein the identification comprises a phone number, and the method further comprises retrieving a name corresponding to the phone number from an address book of the device, and retrieving to-do content from a to-do list of the device according to the name.

13. The method of claim 12 further comprising displaying the to-do content on the device.

14. The method of claim 11 further comprising checking a system time, and performing the corresponding instruction according to the system time.

15. The method of claim 11 wherein the instruction comprises displaying a string.

16. The method of claim 15 wherein the identification comprises a phone number, and the string comprises billing information therefor.

17. The method of claim 14 wherein the identification comprises a phone number, and the instruction comprises displaying billing information for the phone number at the system time.

18. The method of claim 11 wherein the instruction comprises generating audio output.

19. The method of claim 11 wherein the device is a mobile phone, a smart phone, or a PDA.

20. The method of claim 11, wherein the device is part of an integrated circuit (IC) in a mobile phone.
